(19) United States
(12) Patent Application Publication
(10) Pub. No.: US 2007/0177545 A1
(43) Pub. Date: Aug. 2, 2007

(54) System and method for allocating sub-channels in a network

(76) Inventors: Kadathur S. Natarajan, Wilmette, IL (US); Masahito Asa, Tokyo (JP); David T. Chen, Palatine, IL (US)

Correspondence Address: MOTOROLA, INC., 1303 EAST ALGONQUIN ROAD, IL01/3RD, SCHAUMBURG, IL, 60196, US

(21) Appl. No.: 11/342,518

(22) Filed: Jan. 30, 2006

(51) Int. Cl. H04Q 7/00

(52) U.S. Cl. 370/331

(57) ABSTRACT

At least one operating condition is determined for a first mobile subscriber station (104) that is operating in an orthogonal frequency division multiple access (OFDMA) network. The first mobile subscriber station (104) is handed off from a base station (102) to a relay station (110). Based upon the at least one operating condition, at least one sub-channel is subsequently assigned from a plurality of sub-channels of a frequency band to the first mobile subscriber station (104) in order to provide an assigned sub-channel resource to the first mobile subscriber station (104). The assigned sub-channel resource can potentially be any of the plurality of sub-channels of the frequency band.

### FIELD OF THE INVENTION

The field of the invention relates to transmitting communications across networks and, more specifically, to providing channel assignments for mobile subscriber stations operating within these networks.

### BACKGROUND OF THE INVENTION

Mobile subscriber stations communicate with base stations, relay stations, and each other over communication channels. These communication channels are typically further subdivided into sub-channels. Various network entities, such as the base stations and relay stations, assign or otherwise facilitate allocation of the sub-channels to the mobile subscriber stations.

More specifically, in these systems, a base station communicates with mobile subscriber stations and with relay stations using one large set of sub-channels. The relay station, in turn, communicates with a subordinate set of mobile subscriber stations using a smaller set of sub-channels (chosen from the larger set of sub-channels) in order to minimize interference between the mobile subscriber stations, or increase range or coverage of the wireless system. The relay station also performs functions similar to a full base station across the smaller set of sub-channels.

In previous approaches, the sub-channel division between the base station and the relay station was fixed and did not vary. Specifically, a specific set of sub-channels was always assigned to the base station and the remaining set of sub-channels was assigned to the relay station.

While these previous approaches reduced the amount of interference between mobile subscriber stations or increased the range or coverage, other problems were created that downgraded system performance. For example, in these previous approaches, the base station suffered from a reduced capacity since the base station could not use the full set of available sub-channels. Therefore, for example, even when there were no mobile subscriber stations operating at the relay station, sub-channels were still available and reserved for these non-existent mobile subscriber stations at the relay station. Since there was a fixed boundary between the sub-channels assigned to the base station and the relay station, the base station was denied access to these unused resources in these previous approaches. The resultant reduction of capacity resulted in slower communications to/from mobile subscriber stations, general reduction of system efficiency, dropped calls, and the general degradation of the user experience with the system.

### BRIEF DESCRIPTION OF THE DRAWINGS

FIG. 1 is a block diagram of a system for allocating sub-channels according to the present invention;

FIG. 2 is a block diagram of a frequency bandwidth with sub-channel assignment according to the present invention;

FIG. 3 is a block diagram of a frequency bandwidth with sub-channel assignment according to the present invention;

FIG. 4 is a block diagram of a frequency bandwidth with sub-channel assignment according to the present invention;

FIG. 5 is a block diagram of a frequency bandwidth with sub-channel assignment according to the present invention;

FIG. 6 is a block diagram of a frequency bandwidth with sub-channel assignment according to the present invention;

FIG. 7 is a flowchart of one approach for performing channel assignment according to the present invention; and

FIG. 8 is a block diagram of a device for performing channel assignment according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method for facilitating sub-channel assignment in a network allows any sub-channel to be selected from a frequency band so that mobile subscriber stations can operate more efficiently. No fixed division exists between available sub-channels assigned to mobile subscriber stations operating at base stations or relay stations. Consequently, mobile subscriber stations may be potentially assigned to any available sub-channel or group of sub-channels in the frequency band allowing for the more efficient allocation of network resources.

In many of these embodiments, at least one operating condition is determined for a mobile subscriber station that is operating in an orthogonal frequency division multiple access (OFDMA) network. The mobile subscriber station is handed off from a base station to a relay station. Based upon the at least one operating condition, at least one sub-channel is subsequently assigned from a plurality of sub-channels of a frequency band to the mobile subscriber station in order to provide an assigned sub-channel resource to the mobile subscriber station. The assigned sub-channel resource can potentially be any of the plurality of sub-channels of the frequency band.

The assigned sub-channel resource can be divided into a first time portion and a second time portion. The mobile subscriber station can be allocated to the first time portion and another mobile subscriber station to the second time portion. Alternatively, the mobile subscriber station may be assigned to the entire time period of the assigned sub-channel resource.

A variety of operating conditions can be determined. For example, the signal strength at the mobile subscriber station, the link quality between the mobile subscriber station and the relay station, the burst profile, the number of mobile subscriber stations that have been handed off to the relay station, or the traffic load at the mobile subscriber station can be determined.

In many of these embodiments, the assigned sub-channel resource can be adjusted on a per-frame basis. All of the plurality of sub-channels of the frequency band can be assigned to the base station when no mobile subscriber stations are assigned to the relay station. The mobile subscriber station may initiate the handoff of the first mobile subscriber station from the base station to the relay station.

Thus, a system and method are provided that allow for the efficient allocation of sub-channel resources. In the approaches described herein, there is no fixed boundary between the sub-channels assigned to a base station and a relay station leading to the efficient allocation of resources while still providing relief from interference between mobile subscriber stations.

In addition, when OFDMA-compliant technology is employed, these approaches improve the provided coverage and throughput with the use of a fixed set of repeaters and the nearly optimal use of burst profiles between mobile subscriber stations and relay stations. The average number of mobile subscriber stations in a cell may also remain the same while the percentage use of higher order Modulation and Coding Schemes (MCSs) increases.

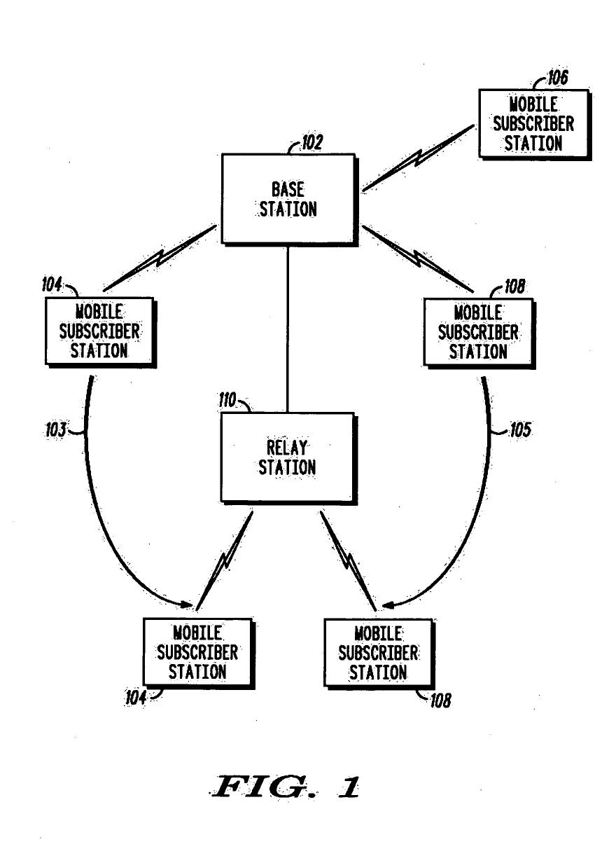

Referring now to FIG. 1, one example of a system for allocating sub-channels of a frequency band to mobile subscriber stations is described. A base station 102 is communicatively coupled to a relay station 110. Preferably, the coupling may be via a wireless link. However, a wired link may also be used. The base station 102 communicates with mobile subscriber stations 104, 106, and 108. The mobile subscriber station 104 moves along a path 103 from the base station 102 to become associated with the relay station 110. The mobile subscriber station 106 may move along a path 105 to become associated with the relay station 110. Although only one base station, one relay station, and three mobile subscriber stations are shown in the system of FIG. 1, it will be understood that any number of base stations, relay stations, or mobile subscriber stations may be used. Preferably, the elements are operating in orthogonal frequency division multiple access (OFDMA) network or OFDMA-like network. However, other types of networks may also be used. In addition, although the description herein is of a mobile subscriber station moving from a base station to a relay station, the approaches described are equally applicable for movement in the opposite direction (i.e., from the relay station to the base station).

The base station 102 includes functionality that allows the base station 102 to transmit and receive information from the mobile subscriber stations and the relay station 110. The base station 102 may also include a control element such as a controller or the like to allow handovers to be made from the base station 102 to the relay station 110 and vice versa. The base station 102 in one preferred approach communicates with mobile subscriber stations 104, 106, and 108 and the relay station 110 via a set of sub-channels spread over a frequency band.

The relay station 110 communicates with its subordinate mobile subscriber stations (e.g., mobile subscriber stations 104 and 108 once they move from the coverage area of the base station 102). The relay station 110 uses a set of the sub-channels in order to communicate with the mobile subscriber stations. The relay station 110 performs similar functions as the base station 102 in order to communicate with the mobile subscriber stations that are within its coverage area.

The mobile subscriber stations 104, 106, and 108 may be any type of wireless mobile device such as cellular telephones, pagers, personal digital assistants (PDAs), or personal computers. Other examples of mobile subscriber stations are possible.

In one example of the operation of the system of FIG. 1, an operating condition or operating conditions are determined for the mobile subscriber station 104. A variety of operating conditions can be determined. For example, the signal strength at the first mobile subscriber station, the link quality between the first mobile subscriber station and the relay station, the burst profile, the number of mobile subscriber stations that have been handed off to the relay station, or the traffic load at the first mobile subscriber station can be determined. At this point, all of the plurality of sub-channels of the frequency band can be assigned to the base station since no mobile subscriber stations are yet assigned to the relay station 110.

The mobile subscriber station 104 is then handed off from the base station 102 to the relay station 110 as shown by the arrow 103. Based upon the determined operating conditions, at least one sub-channel is subsequently assigned from a plurality of sub-channels of a frequency band to the mobile subscriber station 104 in order to provide an assigned sub-channel resource to the mobile subscriber station 104. The assigned sub-channel resource can potentially be any of the plurality of sub-channels of the frequency band.

The assigned sub-channel resource can be divided into a first time portion and a second time portion. The mobile subscriber station 104 can be allocated to the first time portion and the mobile subscriber station 108 (which has also been handed off to the relay station 110) to the second time portion. Alternatively, the mobile subscriber station 104 may be assigned to the entire time period of the assigned sub-channel resource. Once assigned, the assigned sub-channel resource can be adjusted on a per-frame basis.

In another example of the operation of the system of FIG. 1, when one or more mobile subscriber stations are handed over to the relay station 110, a multi-hop zone is set up to serve the mobile subscriber stations that were handed over to the relay station 110 and normal base station traffic is restricted from using the multi-hop zone channels. Initially, the base station 102 may associate the highest burst profile (e.g., modulation level and code rate) for use between the mobile subscriber station and the selected relay station 110. After each frame, the burst profile for use between the mobile subscriber station and its relay station 110 may be adjusted to reflect the measured link condition.

The number of sub-channels assigned to the multi-hop zone may be adjusted on a per-frame basis an may depend upon factors such as the number of mobile subscriber stations that have been handed over to the relay station, the link quality between each mobile subscriber station and relay station (as determined on a per-frame basis), the traffic load of each mobile subscriber station, or the burst profile (e.g., code rate and modulation level) of the mobile subscriber station operating at the relay station.

In one example, there will be multiple relay stations associated with a base station. Assuming that there are K relay stations that are associated with a base station, then each relay station i will have Sᵢ sub-channels reserved for repeater operation for i=1 . . . K. The assignment of sub-channels to a multi-hop zone should preferably attempt to allow the mobile subscriber station to use the best Modulation and Coding Scheme (MCS). For example, sub-channel i can serve a mobile subscriber station in the multi-hop zone with 64 QAM and ⅔ code rate while sub-channel j can serve the mobile subscriber station with 16 QAM and ½ code rate. Then, sub-channel i can be assigned to the multi-hop zone and the relay station should assign sub-channel i to serve that particular mobile subscriber station.

Other advantages are possible using the present approaches. For example, the relay station can be placed where needed as the multi-hop zones are dynamically established and removed. In addition, the mobile subscriber station may select a relay station when poor RF conditions exist with the base station. Furthermore, mobile subscriber stations may be handed over to relay stations under the same base station.

Coordinated resource allocation across relay stations and base stations is also possible. Consequently, burst profiles may be used near optimally, and since either the network or the mobile subscriber station are aware of the identity of the sub-channel that allows the best (or better) RF conditions and traffic burst profile, the hand over of the mobile subscriber station can be better initialized and coordinated between a base station and a relay station.

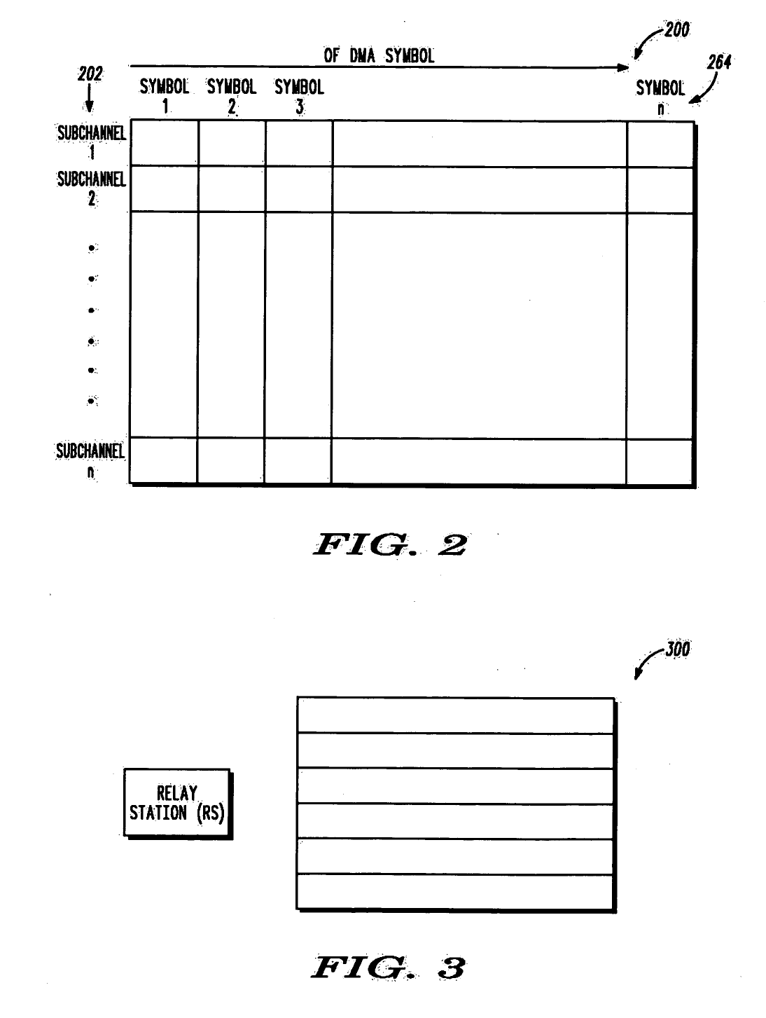

Referring now to FIG. 2, one example of a frequency span that is divided into sub-channels is described. A frequency band 200 includes a plurality of sub-channels 202. Each of the sub-channels 202 is divided into a plurality of segments 204. Each of the segments may be a separate time period and have a separate OFDMA symbol. All of the sub-channels 202 can be assigned to any mobile subscriber station no matter whether the mobile subscriber station is operating at a base station or the mobile subscriber station is operating at a relay station. In other words, there is no fixed boundary between the sub-channels assigned to the base station and sub-channels assigned to the relay station.

One or more of the sub-channels 202 may be assigned to the same mobile subscriber station. These sub-channels may be contiguous in frequency or the frequencies can be split. The segments 204 may also be split. For example, some of the segments of each sub-channel 202 may be assigned to one mobile subscriber station while others of the segments 204 may be assigned to another mobile subscriber station.

FIGS. 3-6 describe one example of how sub-channels may be assigned as mobile subscriber stations move in and out of the coverage area of a relay station. It will be realized that the movements of mobile subscriber stations and resultant sub-channel assignments illustrated in these figures are only one example, and that other movements and/or sub-channel assignments may be possible.

Referring now to FIG. 3, one example of an approach for assigning sub-channels to a mobile subscriber station is described. A relay station (RS) has no mobile subscriber stations assigned. Consequently, no sub-channels are assigned from the frequency spectrum 300 since no mobile subscriber stations are present.

Referring now to FIG. 4, the assignment of sub-channels in the frequency band after a mobile subscriber station is assigned to the relay station (RS) is described. A mobile subscriber station (MSS1) becomes associated with the relay station (RS). The mobile subscriber station (MSS1) is assigned to the sub-channel (SC1). The choice of the sub-channel (SC1) is not fixed. Potentially any sub-channel may be selected from the frequency band 300.

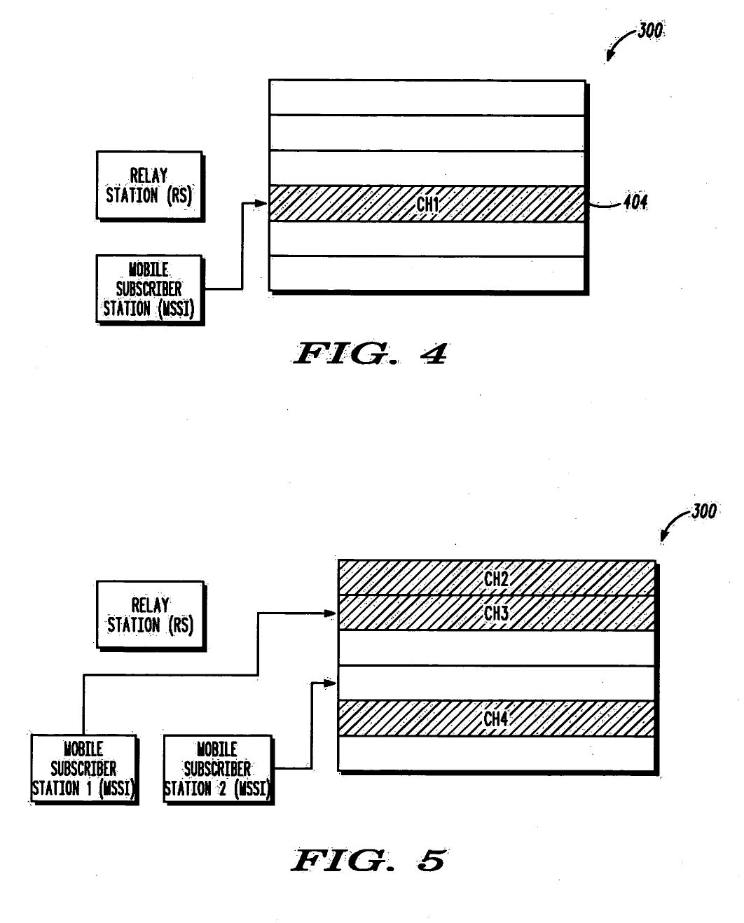

Referring now to FIG. 5, the assignment of sub-channels to a mobile subscriber station after a second mobile subscriber station becomes associated with the relay station is described. A second mobile subscriber station (MSS2) moves into the coverage area and becomes associated with the relay station (RS). Sub-channel assignment occurs such that the mobile subscriber station (MSS1) is assigned new sub-channels channels (SC2-3) and the mobile subscriber station (MSS2) is assigned a sub-channel (SC4). However, potentially any sub-channel may be selected from the frequency band 300.

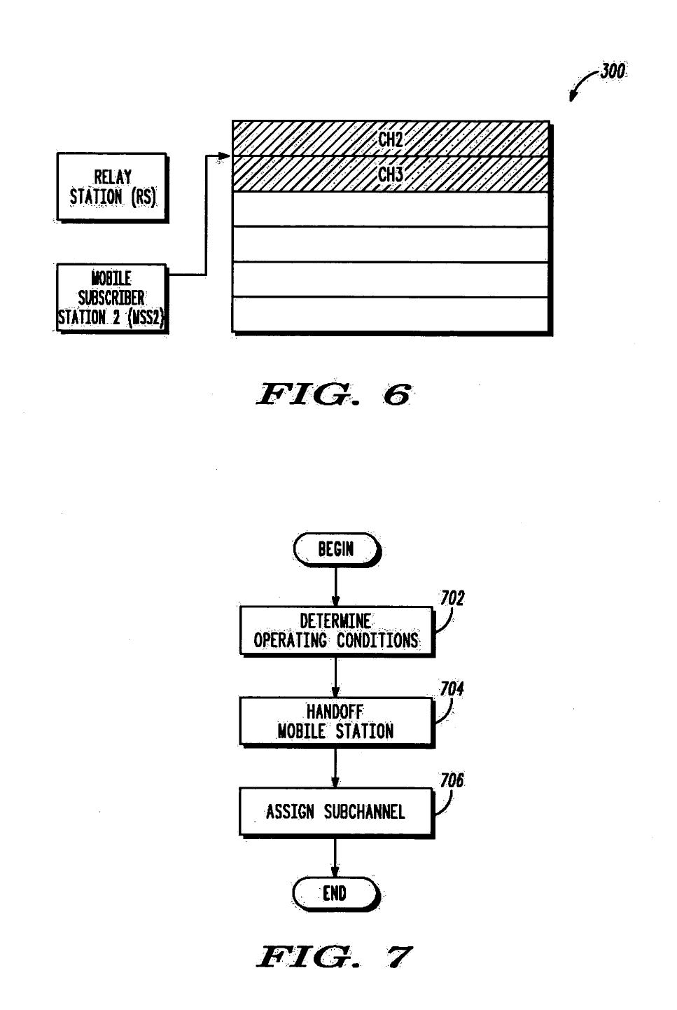

Referring now to FIG. 6, the assignment of sub-channels is described after one of the mobile subscriber stations (MSS1) leaves the coverage area of the relay station (RS). In this case, the mobile subscriber station (MSS1) leaves the coverage area of the relay station (RS) and the channels (CH2-3) originally assigned to the mobile subscriber station (MSS1) are available for re-assignment to the other mobile subscriber stations. In FIG. 6, the channels are re-assigned the mobile subscriber station (MSS2). As before, potentially any sub-channel may be selected from the frequency band 300.

Referring now to FIG. 7, one example of an approach for facilitating sub-channel assignment in an orthogonal frequency division multiple access (OFDMA) network is described. At step 702, at least one operating condition of a first mobile subscriber station is determined. A variety of operating conditions can be determined. For example, the signal strength at the first mobile subscriber station, the link quality between the first mobile subscriber station and the relay station, the burst profile, the number of mobile subscriber stations that have been handed off to the relay station, or the traffic load at the first mobile subscriber station can be determined.

At step 704, the mobile subscriber station is handed off from a base station to a relay station. At step 706, based upon the at least one operating condition, at least one sub-channel from a plurality of sub-channels of a frequency band is assigned to the first mobile subscriber station to provide an assigned sub-channel resource. The assigned sub-channel resource can potentially be any of the plurality of sub-channels of the frequency band.

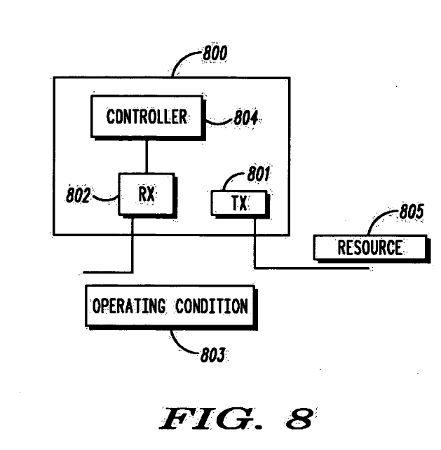

Referring now to FIG. 8, one example of a base station for making sub-channel assignments is described. The base station 800 includes a controller 804 and a receiver 802 and a transmitter 801.

The receiver 802 receives at least one operating condition 803 of a mobile subscriber station that is operating in an orthogonal frequency division multiple access (OFDMA) network. Other types of networks can also be used.

The controller 804 is programmed to, based upon the at least one operating condition 803 and subsequent to receiving an indication at the receiver 802 that the first mobile subscriber station moved from the base station to a relay station, assign a sub-channel resource 805. The assigned sub-channel resource 805 can potentially be any of the plurality of sub-channels on the frequency band.

The controller 804 may also divide the assigned sub-channel resource 805 into a first time portion and a second time portion, and to allocate the mobile subscriber station to the first time portion and another mobile subscriber station to the second time portion. Alternatively, the controller 804 is further programmed to assign the mobile subscriber station to an entire time period of the assigned sub-channel resource. The controller 804 is further programmed to dynamically adjust the assigned sub-channel resource on a per-frame basis. Specifically, the identity and/or characteristics of the assigned sub-channel may be dynamically changed over time based upon the measured signal strength at the first mobile subscriber station, the link quality between the first mobile subscriber station and a relay station, the burst profile, the number of mobile subscriber stations that have been handed off to the relay station, and the traffic load at the first mobile subscriber station. Addition factors may also be used. In addition, the number of sub-channels used and/or the portions of the sub-channels used may also be varied over time based upon these or other factors.

Thus, a system and method are provided that allow for the efficient allocation of sub-channel resources. In the approaches described herein, there is no fixed boundary between the sub-channels assigned to a base station and a relay station leading to the efficient allocation of resources while still providing relief from interference between mobile subscriber stations or increase the range or coverage of the wireless system.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method for facilitating sub-channel assignment in a network comprising:
in an orthogonal frequency division multiple access (OFDMA) network:
determining at least one operating condition of a first mobile subscriber station;
handing off the first mobile subscriber station from a base station to a relay station; and
based upon the at least one operating condition, subsequently assigning at least one sub-channel from a plurality of sub-channels of a frequency band to the first mobile subscriber station to provide an assigned sub-channel resource such that the assigned sub-channel resource can potentially be any of the plurality of sub-channels of the frequency band.

2. The method of claim 1 further comprising dividing the assigned sub-channel resource into a first time portion and a second time portion, and allocating the first mobile subscriber station to the first time portion and a second mobile subscriber station to the second time portion.

3. The method of claim 1 further comprising assigning the first mobile subscriber station to an entire time period of the assigned sub-channel resource.

4. The method of claim 1 wherein determining the at least one operating condition comprises determining at least one operating condition selected from a group comprising: a signal strength at the first mobile subscriber station; link quality between the first mobile subscriber station and the relay station; a burst profile; a number of mobile subscriber stations that have been handed off to the relay station; and a traffic load at the first mobile subscriber station.

5. The method of claim 1 further comprising adjusting the assigned sub-channel resource on a per-frame basis.

6. The method of claim 1 further comprising assigning all of the plurality of sub-channels of the frequency band to the base station when no mobile subscriber stations are assigned to the relay station.

7. The method of claim 1 further comprising the first mobile subscriber station initiating the handoff of the first mobile subscriber station from the base station to the relay station.

8. A method for facilitating sub-channel assignment in a network comprising:
in an orthogonal frequency division multiple access (OFDMA) network:
receiving at least one operating condition of a mobile subscriber station;
facilitating a handover of the mobile subscriber station from a base station to a relay station;
based upon the at least one operating condition, subsequently determining at least one sub-channel from a plurality of sub-channels of a frequency band to the mobile subscriber station such that the determined at least one sub-channel can potentially be any of the plurality of sub-channels on the frequency band; and
dynamically adjusting the determined at least one sub-channel based upon changes in the at least one operating condition.

9. The method of claim 8 further comprising dividing the determined at least one sub-channel into a plurality of time portions, and allocating the mobile subscriber station to a selected one of the plurality of time portions.

10. The method of claim 8 further comprising assigning the mobile subscriber station to an entire time period of the determined at least one sub-channel.

11. The method of claim 8 wherein determining the at least one operating condition comprises determining at least one operating condition selected from a group comprising: a signal strength at the mobile subscriber station; link quality between the mobile subscriber station and a relay station; a burst profile; a number of mobile subscriber stations that have been handed off to the relay station; and a traffic load at the mobile subscriber station.

12. A base station comprising:
a receiver for receiving at least one operating condition of a first mobile subscriber station that is operating in an orthogonal frequency division multiple access (OFDMA) network; and
a controller, the controller coupled to the receiver, the controller being programmed to, based upon the at least one operating condition and subsequent to receiving an indication at the receiver that the first mobile subscriber station moved from the base station to a relay station, assign at least one sub-channel from a plurality of sub-channels of a frequency band to the first mobile subscriber station to provide an assigned sub-channel resource such that the assigned sub-channel resource can potentially be any of the plurality of sub-channels on the frequency band.

13. The base station of claim 12 wherein the controller is further programmed to divide the assigned sub-channel resource into a first time portion and a second time portion, and to allocate the first mobile subscriber station to the first time portion and a second mobile subscriber station to the second time portion.

14. The base station of claim 12 wherein the controller is further programmed to assign the first mobile subscriber station to an entire time period of the assigned sub-channel resource.

15. The base station of claim 12 wherein the at least one operating condition is selected from a group comprising: a signal strength at the first mobile subscriber station; link quality between the first mobile subscriber station and a relay station; a burst profile; a number of mobile subscriber stations that have been handed off to the relay station; and a traffic load at the first mobile subscriber station.

16. The base station of claim 12 wherein the controller is further programmed to dynamically adjust the assigned sub-channel resource on a per-frame basis.

17. The base station of claim 12 where the controller comprises means for assigning the at least one sub-channel resource from a plurality of sub-channels of a frequency band to the first mobile subscriber station to provide the assigned sub-channel resource as a function, at least in part, of the at least one operating condition such that the assigned sub-channel resource can potentially be any of the plurality of sub-channels of the frequency band.
